(19) United States
(12) Patent Application Publication
(10) Pub. No.: US 2011/0052971 A1
(43) Pub. Date: Mar. 3, 2011

(54) BATTERY

(76) Inventors: Masato Fujikawa, Osaka (JP); Tomohiko Yokoyama, Osaka (JP); Mikinari Shimada, Osaka (JP)

(21) Appl. No.: 12/747,752

(22) PCT Filed: Nov. 5, 2009
(86) PCT No.: PCT/JP2009/005875

§ 371 Date: Jun. 11, 2010

(30) Foreign Application Priority Data
Dec. 15, 2008 (JP) 2008-318532

(51) Int. Cl. H01M 2/26

(52) U.S. Cl. 429/161

(57) ABSTRACT

In a battery, an electrode group (4) and an electrolyte are together sealed in a battery case (10). The electrode group (4) includes a positive electrode (1) and the negative electrode (2) which are wound or stacked with a separator (3) interposed therebetween. At least one of the positive electrode (1) and the negative electrode (2) includes a current collector (2A) and an active material layer (2B), and a lead (6) is electrically connected to an exposed portion (21) of the current collector (2A). The lead (6) is arranged to extend from the exposed portion (21) to the outside of the current collector (2A) such that the lead (6) straddles a first edge (21a) which is one of edges constituting the exposed portion (21), and is welded to the exposed portion (21) at a position close to the first edge (21a).

### TECHNICAL FIELD

The present invention relates to batteries, and specifically to batteries having leads.

### BACKGROUND ART

Generally, chemical batteries such as lithium ion secondary batteries include electrode groups accommodated in metal cases or by laminated sheets. Such an electrode group includes a positive electrode and a negative electrode wound or stacked with a separator interposed therebetween. The separator serves to separate the positive electrode from the negative electrode, and serves to retain an electrolyte. The metal case or the laminated sheet is sealed with a sealing member. Such a chemical battery may further include a positive electrode lead and a negative electrode lead. A cylindrical battery and a square battery will be taken as examples, and example structures of a positive electrode lead and a negative electrode lead of each of the cylindrical battery and the square battery will be described below.

In the cylindrical battery, the positive electrode lead extends from a positive electrode current collector of an electrode group to a sealing member (serving as a positive electrode terminal), and is welded to the positive electrode current collector and the sealing member. The negative electrode lead extends from the outermost circumference of the electrode group along an inner side surface and a bottom surface of a battery case (serving as a negative electrode terminal) to a center portion of the bottom surface, and is welded to the negative electrode current collector and the center portion of the bottom surface of the battery case.

In a square battery using aluminum as its battery case material, a metal terminal (serving as a negative electrode terminal) made of, for example, nickel, and insulated from the environment is provided at a part of a sealing member made of aluminum. The positive electrode lead extends from a positive electrode current collector of an electrode group to a part of the sealing member which is made of aluminum (serving as a positive electrode terminal), and is welded to the positive electrode current collector and the part of the sealing member which is made of aluminum. The negative electrode lead extends from a negative electrode current collector of the electrode group to the metal terminal, and is welded to the negative electrode current collector and the metal terminal.

As a negative electrode lead material, nickel is generally used in view of an anti-corrosion characteristic and chemical stability. However, nickel has a relatively large specific resistance (6.84 μΩ·m), and thus when the power of the battery increases, causing a large current to flow through the negative electrode lead, the heat value of the negative electrode lead increases. Then, Patent Document 1 describes using copper, which is lower in specific resistance than nickel, as a negative electrode lead material.

### Citation List

### Patent Document

Patent Document 1: Japanese Patent Publication No. H11-86868

### SUMMARY OF THE INVENTION

### Technical Problem

It is required these days to ensure the safety of a battery even when an external short circuit occurs.

The present invention was devised in consideration of these conventional circumstances. It is an objective of the present invention to ensure the safety of a battery even when an external short circuit occurs.

### Solution to the Problem

In a battery according to the present invention, an electrode group formed by winding or stacking a positive electrode and a negative electrode with a porous insulating layer interposed therebetween is sealed in a battery case together with an electrolyte. At least one of the positive electrode and the negative electrode includes a current collector, and an active material layer provided on a surface of the current collector such that a portion of the surface of the current collector is exposed. A lead is electrically connected to the exposed portion of the surface of the current collector which is exposed from the active material layer. The lead is disposed to extend from the exposed portion to an outside of the current collector such that the lead straddles a first edge which is one of edges constituting the exposed portion, and is welded to the exposed portion at a position close to the first edge.

As described later, the inventors of the present application found this time that heat was generated at a lead when an external short circuit occurred, and consequently accomplished the invention of the present application. The battery described above allows heat generated at the lead to be released rapidly to the current collector, so that it is possible to reduce the temperature rise at the lead at the occurrence of an external short circuit.

Here, “a position close to the first edge” is a position closer to the first edge in comparison to a welding point of a lead to a current collector in conventional batteries (whose welding point is 8 mm or more away from the first edge of the current collector), is preferably a position 5 mm or less away from the first edge, and is more preferably a position greater than or equal to 0.1 mm and less than or equal to 3 mm away from the first edge. The closer to the first edge the welding point of the lead to the current collector is, the more rapidly the heat generated at the lead can be released to the current collector. However, when the welding point of the lead to the current collector is too close to the first edge, it becomes difficult to ensure the weld strength of the lead to the current collector. Moreover, it is necessary to precisely set the welding position of the lead to the current collector, so that it takes time to weld the lead to the current collector.

Moreover, “the lead is welded at a position 5 mm or less away from the first edge” means that the distance between the first edge and an edge of the welding point located close to the first edge is 5 mm or less. Likewise, “the lead is welded at a position greater than or equal to 0.1 mm and less than or equal to 3 mm away from the first edge” means that the distance between the first edge and an edge of the welding point located close to the first edge is greater than or equal to 0.1 mm and less than or equal to 3 mm.

Moreover, when the battery is a nonaqueous electrolyte secondary battery, the “electrolyte” is an electrolyte solution or a polymer electrolyte.

In the battery according to the present invention, the lead is preferably welded to the exposed portion at two or more points, and a welding point of the welding points which is closest to the first edge preferably has an area larger than that of the other welding point, and has an area of, for example, 2 mm² or larger.

The lead is usually welded to the current collector at a plurality of points. As described later, the inventors of the present application confirmed this time that a welding point of the plurality of welding points which is closest to the first edge released most of the heat generated at the lead to the current collector. Thus, the heat generated at the lead can be released to the current collector more rapidly in the battery described above than in the case where the plurality of welding points have the same area.

In the battery according to the present invention, the lead is preferably welded to the exposed portion at three or more points, the welding points of the lead to the current collector are preferably disposed at intervals in a longitudinal direction of the lead, and an interval between a first welding point of the welding points which is located closest to the first edge and a second welding point located adjacent to the first welding point is preferably larger than that between the other welding points adjacent to each other.

Here, “the interval between the first welding point and the second welding point” means the interval between an edge of the first welding point which is located close to the second welding point and an edge of the second welding point which is located close to the first welding point.

Conventionally, the intervals between the welding points are equal to each other. In this case, if the first welding point is shifted to a position close to the first edge, the interval between the first welding point and the second welding point becomes larger than the interval between the other welding points adjacent to each other.

In the battery according to the present invention, the first edge preferably extends in a longitudinal direction of the current collector, and a length of a portion of the lead which abuts the exposed portion is preferably equal to or less than ⅓ of a length of the current collector in a width direction.

In the battery according to the present invention, the lead is welded to the exposed portion at a position closer to the first edge in comparison to conventional configurations (the lead is conventionally welded to the exposed portion at a position 8 mm or more away from the first edge of the current collector), so that the length of a portion of the lead which abuts the exposed portion can be shorter than that of the conventional configurations. In this way, it is possible to reduce the price of the battery. Moreover, an increase in volume of the electrode group can be prevented, so that it is possible to increase the capacity.

In a preferable embodiment described later, the lead is made of nickel, and the battery is a lithium ion secondary battery. Since the lead is made of nickel, it is possible to ensure the weld strength of the lead to the exposed portion of the current collector and to the electrode terminal.

### Advantages of the Invention

According to the present invention, the safety of a battery can be ensured even when an external short circuit of the battery occurs.

### BRIEF DESCRIPTION OF THE DRAWINGS

FIG. 1 is a cross-sectional view illustrating a wound, cylindrical lithium ion secondary battery.

FIG. 2 is a plan view illustrating a state in which a negative electrode lead is welded to an exposed portion of a negative electrode current collector of a conventional configuration.

FIG. 3 is a plan view illustrating an example of a state in which a negative electrode lead is welded to an exposed portion of a negative electrode current collector of a first embodiment.

FIG. 4 is a plan view illustrating another example of a state in which the negative electrode lead is welded to the exposed portion of the negative electrode current collector of the first embodiment.

FIG. 5 is a plan view illustrating yet another example of a state in which the negative electrode lead is welded to the exposed portion of the negative electrode current collector of the first embodiment.

FIG. 6 is a plan view illustrating a state in which a positive electrode lead is welded to an exposed portion of a positive electrode current collector of a second embodiment.

FIG. 7 is a table showing results of temperature measurement of first to ninth examples and first to third comparative examples.

FIG. 8 is a view specifically illustrating a first portion 6a, a second portion 6b, and a third portion 6c which constitute a negative electrode lead.

FIG. 9 is an enlarged cross-sectional view illustrating a state in which the negative electrode lead is welded to an exposed portion of a negative electrode current collector.

FIG. 10 is an enlarged cross-sectional view illustrating a state in which the negative electrode lead is welded to a battery case.

FIG. 11 is a view specifically illustrating a first portion 5a, a second portion 5b, a third portion 5c which constitute a positive electrode lead.

FIG. 12 is an enlarged cross-sectional view illustrating a state in which the positive electrode lead is welded to an exposed portion of a positive electrode current collector.

### DESCRIPTION OF EMBODIMENTS

Prior to description of embodiments of the present invention, the logic that the present invention was accomplished by the inventors of the present application will be described below.

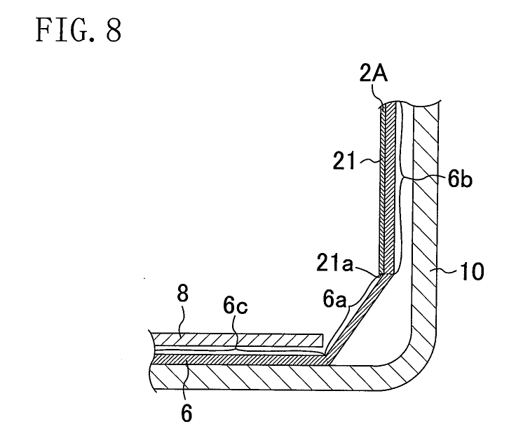

It is known that the occurrence of an external short circuit makes it difficult to ensure the safety of a battery. Then, for the purpose of ensuring the safety of a battery even when an external short circuit occurs, the inventors of the present application investigated what was going on in the battery when the external short circuit occurred. Specifically, an external short circuit of a cylindrical lithium ion secondary battery was caused to investigate what was going on in the cylindrical lithium ion secondary battery. As a result, it was found that when the external short circuit occurred, significant heat was generated at a lead, in particular, at a negative electrode lead, and the temperature was much higher at a portion of the negative electrode lead than at the other portions of the negative electrode lead. The inventors of the present application suggested two reasons for the above findings. The two reasons will be described with reference to FIG. 8.

FIG. 8 is a view specifically illustrating a first portion 6a, a second portion 6b, and a third portion 6c which constitute a negative electrode lead 6. The negative electrode lead 6 extends from an exposed portion 21 of a negative electrode current collector 2A to the outside of the negative electrode current collector 2A while straddling a first edge 21a, is bent at the border between an inner side surface and a bottom surface of a battery case 10, and further extends toward a center portion of the bottom surface of the battery case 10 along the bottom surface of the battery case 10. The first portion 6a is a portion which is provided between the second portion 6b and the third portion 6c, and which does not abut the exposed portion 21 of the negative electrode current collector 2A and the bottom surface of the battery case 10. In other words, the first portion 6a is a portion surrounded by a nonaqueous electrolyte (e.g., an electrolyte solution or a polymer electrolyte). The second portion 6b is a portion of the negative electrode lead 6 which abuts the exposed portion 21 of the negative electrode current collector 2A. The third portion 6c is a portion of the negative electrode lead 6 which abuts the bottom surface of the battery case 10.

As a first reason, the inventors suggested that the resistance of the negative electrode lead 6 was higher than that of the other components of the battery except the negative electrode lead 6. In a lithium ion secondary battery, it is often the case that the negative electrode lead 6 is made of nickel, the negative electrode current collector 2A is made of copper, and a positive electrode lead and a positive electrode current collector are made of aluminum. Since nickel is higher in specific resistance than copper and aluminum, the resistance of the negative electrode lead 6 is higher than that of the negative electrode current collector 2A, than that of the positive electrode lead, and than that of the positive electrode current collector. Moreover, Joule's heat is proportional to the resistance value. Based on these facts, the inventors supposed that the negative electrode lead 6 had the highest heat value when an external short circuit of the lithium ion secondary battery occurred.

As a second reason, the inventors suggested that heat generated at the negative electrode lead 6 due to the external short circuit was released less easily from the first portion 6a than from the second portion 6b and from the third portion 6c. The first portion 6a is surrounded by the nonaqueous electrolyte, and does not abut the exposed portion 21 of the negative electrode current collector 2A and the battery case 10. The second portion 6b abuts the exposed portion 21 of the negative electrode current collector 2A, and part of the second portion 6b is welded to the exposed portion 21 of the negative electrode current collector 2A. The third portion 6c abuts the bottom surface of the battery case 10, and part of the third portion 6c is welded to the battery case 10. The nonaqueous electrolyte contains an organic solution, and thus does not have a high thermal conductivity. The negative electrode current collector 2A and the battery case 10 are made of metal, and thus have a high thermal conductivity. Thus, the inventors supposed that the heat generated at the negative electrode lead 6 was easily released from the second portion 6b to the negative electrode current collector 2A, and from the third portion 6c to the battery case 10, but was less easily released from the first portion 6a.

Based on the above findings and evaluation of the found facts, the inventors of the present application supposed that if the heat value at the negative electrode lead 6 could be reduced, or if the heat generated at the negative electrode lead 6 could rapidly be released not only from the second portion 6b and from the third portion 6c but also from the first portion 6a, it was possible to ensure the safety of the battery when the external short circuit occurred. First, studies conducted by the inventors of the present application in order to reduce the heat value at the negative electrode lead 6 will be described below.

As methods for reducing the heat value at the negative electrode lead 6, the inventors of the present application conceived of two methods as described below. A first method is to change a material for the negative electrode lead 6 from nickel to copper. Since copper is lower in specific resistance than nickel, using copper as a negative electrode lead material can limit the heat value at the negative electrode lead 6 to a value lower than that in conventional configurations.

However, since copper has a low specific resistance, it is very difficult to weld a negative electrode lead made of copper to the exposed portion 21 of the negative electrode current collector 2A and the battery case 10. Moreover, even if the negative electrode lead made of copper could be welded to the exposed portion 21 of the negative electrode current collector 2A and the battery case 10, it is not possible to maintain its sufficient weld strength. Thus, the inventors concluded that it was difficult to use the first method.

A second method is to increase the thickness of the negative electrode lead 6 or to increase the width of the negative electrode lead 6 instead of changing the material for the negative electrode lead 6. When the thickness or the width of the negative electrode lead 6 is increased, the resistance of the negative electrode lead 6 can be reduced, so that it is possible to limit the heat value at the negative electrode lead 6 to a value lower than that in conventional configurations.

However, increasing the thickness or the width of the negative electrode lead 6 increases the volume of an electrode group 4. Moreover, the circularity of the electrode group 4 decreases, thereby reducing the occupancy of the electrode group 4 in the battery case 10. Therefore, when the thickness or the width of the negative electrode lead 6 is increased, it becomes difficult to ensure the filling quantity of an active material. Thus, the inventors concluded that it was difficult to use the second method.

The inventors next conducted a study of rapidly releasing the heat generated at the negative electrode lead 6 not only from the second portion 6b and the third portion 6c but also from the first portion 6a. As a method for rapidly releasing the heat generated at the negative electrode lead 6 also from the first portion 6a, the inventors of the present application contemplated releasing the heat generated at the negative electrode lead 6 from the first portion 6a through the second portion 6b to the negative electrode current collector 2A, or from the first portion 6a through the third portion 6c to the battery case 10. For this purpose, the inventors investigated the process of releasing heat from the second portion 6b and the third portion 6c in detail.

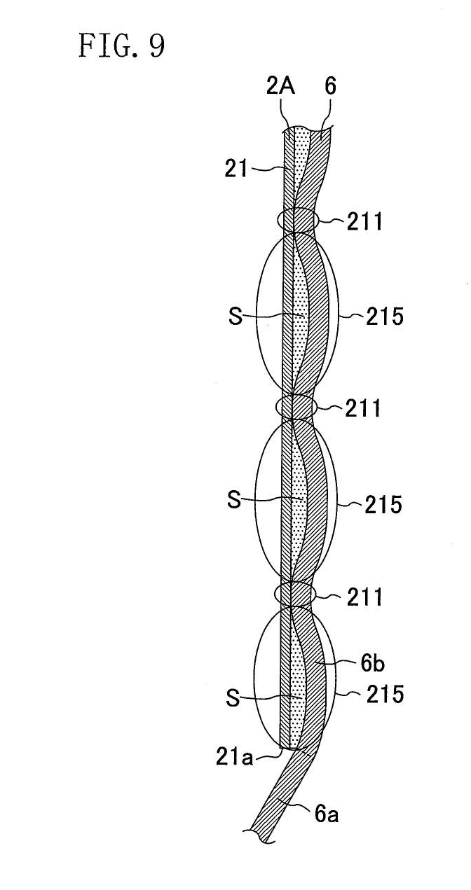

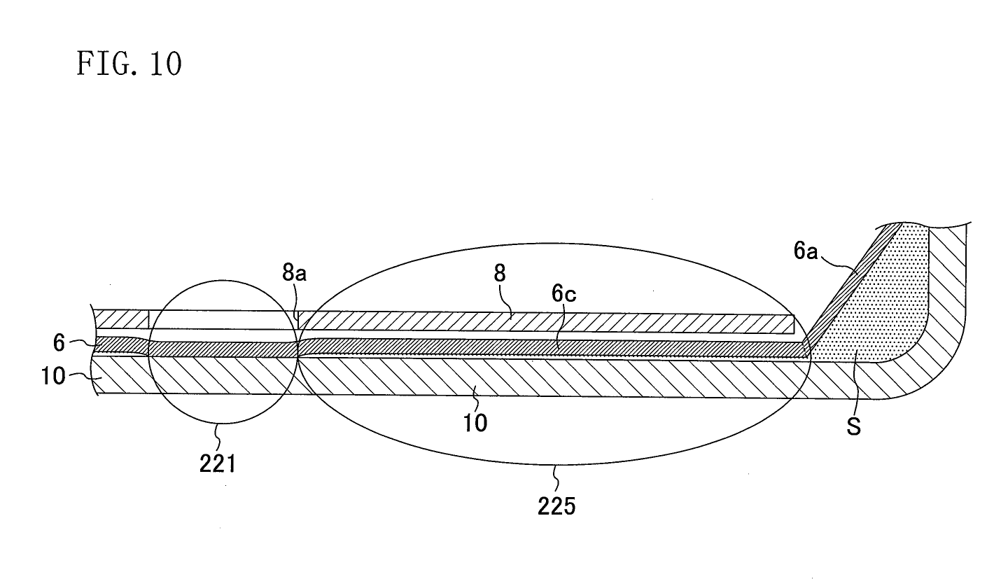

It is generally known that when metal members having different temperatures from each other are brought into contact with each other, heat moves from a metal member having a higher temperature to a metal member having a lower temperature. Therefore, the inventors of the present application initially believed that the heat generated at the negative electrode lead 6 was released to the negative electrode current collector 2A as long as the negative electrode lead 6 abutted the exposed portion 21 of the negative electrode current collector 2A even if the negative electrode lead 6 was not welded to the exposed portion 21 of the negative electrode current collector 2A. Moreover, the inventors of the present application initially believed that the heat generated at the negative electrode lead 6 was released to the battery case 10 as long as the negative electrode lead 6 abutted the bottom surface of the battery case 10 even if the negative electrode lead 6 was not welded to the battery case 10. However, as a result of the detailed investigation on the process of releasing heat from the second portion 6b and the third portion 6c, it was found that only the fact that the negative electrode lead 6 abutted the exposed portion 21 of the negative electrode current collector 2A or the battery case 10 could not sufficiently release the heat generated at the negative electrode lead 6 to the negative electrode current collector 2A or the battery case 10. Reasons for the above findings suggested by inventors of the present application will be described with reference to FIGS. 9 and 10.

FIG. 9 is an enlarged cross-sectional view illustrating a state in which the negative electrode lead 6 is welded to the exposed portion 21 of the negative electrode current collector 2A. FIG. 10 is an enlarged cross-sectional view illustrating a state in which the negative electrode lead 6 is welded to the battery case 10.

At welding points 211 of the negative electrode lead 6 to the exposed portion 21 of the negative electrode current collector 2A, no gaps are provided between the negative electrode lead 6 and the exposed portion 21 of the negative electrode current collector 2A. In contrast, at non-welding points 215 between the negative electrode lead 6 and the exposed portion 21 of the negative electrode current collector 2A, the negative electrode lead 6 simply abuts the exposed portion 21 of the negative electrode current collector 2A. Thus, at the non-welding points 215, gaps (exaggerated in FIG. 9 for purposes of illustration) may be provided between the negative electrode lead 6 and the exposed portion 21 of the negative electrode current collector 2A. Since the nonaqueous electrolyte is filled in the battery case 10, a nonaqueous electrolyte S probably presents in the gaps. That is, the inventors supposed that at the non-welding points 215, the negative electrode lead 6 was disposed on the exposed portion 21 of the negative electrode current collector 2A with the nonaqueous electrolyte S (a member which does not have a high thermal conductivity) provided therebetween, so that the heat generated at the negative electrode lead 6 was less easily released from the second portion 6b to the negative electrode current collector 2A.

Likewise, at welding points 221 of the negative electrode lead 6 to the battery case 10, no gaps are provided between the negative electrode lead 6 and the battery case 10. In contrast, at non-welding points 225 between the negative electrode lead 6 and the battery case 10, the negative electrode lead 6 simply abuts the bottom surface of the battery case 10, so that gaps (exaggerated in FIG. 10 for purposes of illustration) are provided between the negative electrode lead 6 and the battery case 10. Thus, the inventors supposed that at the non-welding points 225, the negative electrode lead 6 was disposed on the bottom surface of the battery case 10 with the nonaqueous electrolyte S interposed therebetween, so that the heat generated at the negative electrode lead 6 was less easily released from the third portion 6c to the battery case 10.

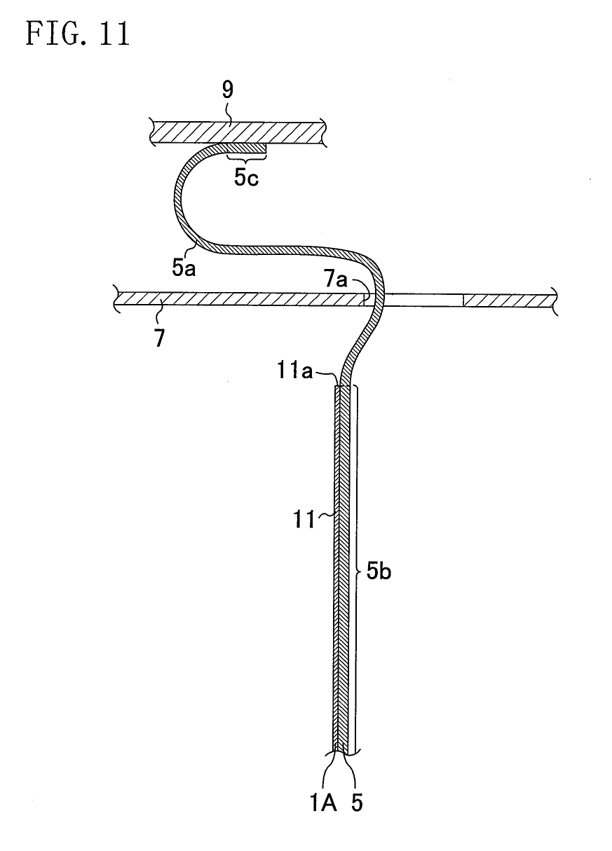

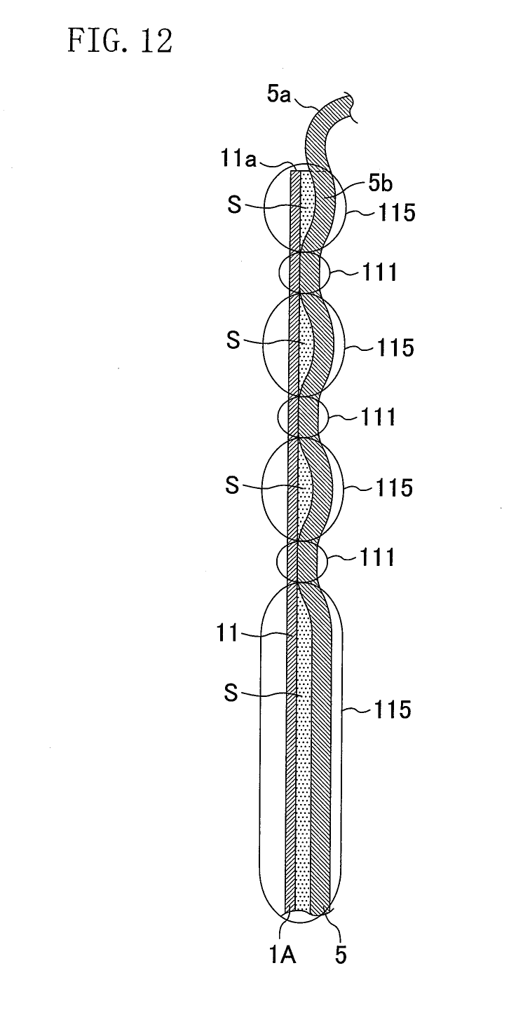

The above description has provided contents of the studies which the inventors of the present application conducted on methods for ensuring the safety of a battery at the occurrence of an external short circuit of the battery in which the resistance of a negative electrode lead was higher than that of a positive electrode lead. The inventors of the present application further studied the case where significant heat was generated at the positive electrode lead when the external short circuit occurred. In existing lithium ion secondary batteries, it is often the case that the resistance of a negative electrode lead is higher than that of a positive electrode lead. However, if the resistance of the negative electrode lead is lower than that in conventional configurations, there is a possibility that the positive electrode lead and the negative electrode lead have the same resistance, or a possibility that the positive electrode lead has a resistance higher than that of the negative electrode lead. This will be described with reference to FIGS. 11 and 12.

FIG. 11 is a view specifically illustrating a first portion 5a, a second portion 5b, a third portion 5c. A positive electrode lead 5 extends from an exposed portion 11 of a positive electrode current collector 1A to the outside of the positive electrode current collector 1A while straddling a first edge 11a, and further extends through a through hole 7a of an upper insulating plate 7 to a lower surface of a sealing plate 9. The first portion 5a is a portion which is provided between the second portion 5b and the third portion 5c, and which does not abut the exposed portion 11 of the positive electrode current collector 1A and the sealing plate 9. In other words, the first portion 5a is a portion surrounded by the nonaqueous electrolyte. The second portion 5b is a portion of the positive electrode lead 5 which abuts the exposed portion 11 of the positive electrode current collector 1A. The third portion 5c is a portion of the positive electrode lead 5 which abuts the lower surface of the sealing plate 9. FIG. 12 is an enlarged cross-sectional view illustrating a state in which the positive electrode lead 5 is welded to the exposed portion 11 of the positive electrode current collector 1A.

The second portion 5b of the positive electrode lead 5 abuts the exposed portion 11 of the positive electrode current collector 1A, and the third portion 5c of the positive electrode lead 5 abuts the sealing plate 9. However, the other portion (the first portion 5a) is surrounded by the nonaqueous electrolyte, and does not abut the exposed portion 11 of the positive electrode current collector 1A and the sealing plate 9. Therefore, when significant heat is generated at the positive electrode lead 5, the heat is presumably less released from the first portion 5a than from the second portion 5b and the third portion 5c, so that the heat remains at the first portion 5a. Moreover, at non-welding points 115 between the positive electrode lead 5 and the exposed portion 11 of the positive electrode current collector 1A, the nonaqueous electrolyte S probably presents between the positive electrode lead 5 and the exposed portion 11 of the positive electrode current collector 1A. Therefore, the heat generated at the positive electrode lead 5 is presumably less easily released to the exposed portion 11 of the positive electrode current collector 1A.

In summary, the inventors of the present application investigated in detail what was going on in a battery when an external short circuit occurred, and consequently found that significant heat was generated at one of the positive electrode lead 5 and the negative electrode lead 6 which had a higher resistance. The inventors also found that a portion of a lead which had a higher resistance and did not abut an exposed portion and an electrode terminal of a current collector (e.g., the first portion 5a of the positive electrode lead 5 or the first portion 6a of the negative electrode lead 6) had a very high temperature. Furthermore, the inventors of the present application evaluated the found facts in detail, and consequently found that only the fact that the lead abutted the exposed portion of the current collector or the electrode terminal (e.g., the positive electrode terminal or the negative electrode terminal) could not release the heat generated at the lead to the current collector or the electrode terminal. Based on these findings, the inventors of the present application accomplished the invention of the present application.

A lead is a member for extracting a current from a battery. In a secondary battery, a lead is a member for supplying a current to a battery in addition to extracting a current. Therefore, it has conventionally been considered that it is sufficient to weld a lead to an exposed portion of a current collector with a strength higher than or equal to a certain level. Thus, welding positions of the lead to the current collector have not been optimized, and the technical aspect of optimizing the welding positions of the lead to the current collector has not even been conceived. However, the inventors of the present application found this time that heat was generated at the lead when the external short circuit occurred. Moreover, the inventors evaluated the found facts in detail, and consequently found that only the fact that the lead abutted the exposed portion of the current collector or the electrode terminal could not sufficiently release the heat generated at the lead to the current collector or to the electrode terminal, but only when the lead was welded to the exposed portion of the current collector or the electrode terminal, the heat generated at the lead could be sufficiently released to the current collector or to the electrode terminal. From further detailed evaluation, the inventors conceived that optimizing the welding positions of the lead to the exposed portion of the current collector could ensure the safety of the battery when the external short circuit occurred, and determined optimal welding positions of the lead to the exposed portion of the current collector. As described above, the present invention is an invention accomplished based on the findings that heat is generated at a lead when an external short circuit occurs, and that most of the heat is released from portions of the lead which are welded to the exposed portion of the current collector and the electrode terminal. Without these findings, studying the welding positions of the lead to the exposed portion of the current collector in detail would not even be considered, so that optimizing the welding positions based on the studying of the welding positions of the lead to the exposed portion of the current collector in detail would never be conceived.

Embodiments of the present invention will be described in detail below with reference to the drawings. Note that the present invention is not limited to the embodiments below. For example, although a lithium ion secondary battery (hereinafter sometimes referred to as a “battery”) will be described in the embodiments below, the present invention is not limited to the lithium ion secondary battery.

### First Embodiment of the Invention

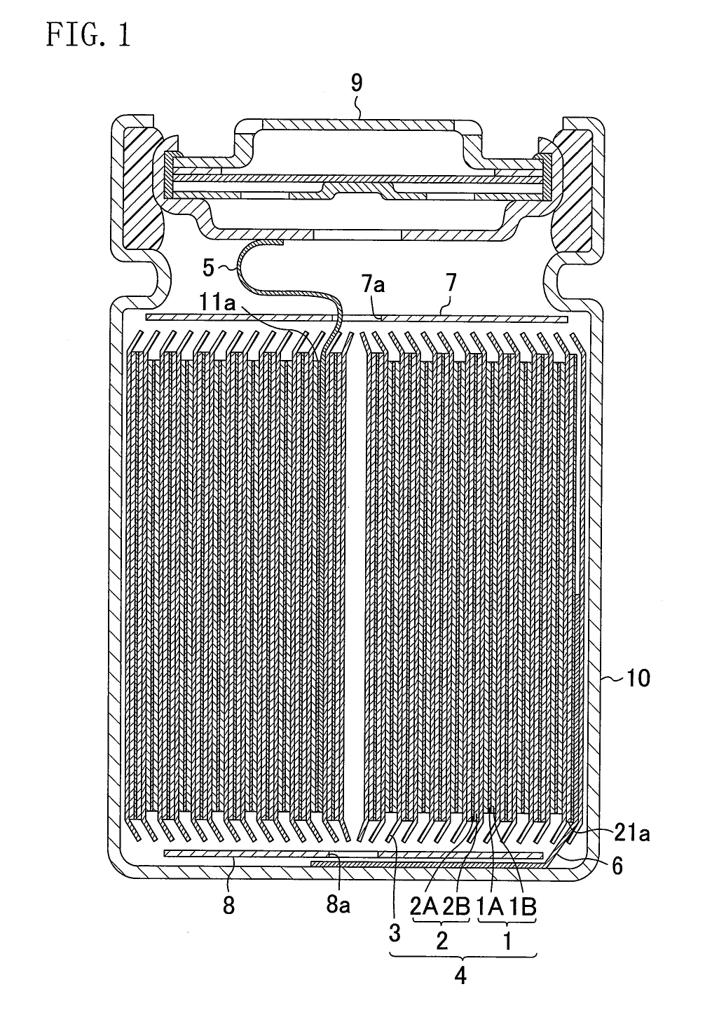

FIG. 1 is a cross-sectional view illustrating a general, wound, cylindrical lithium ion secondary battery.

The wound, cylindrical lithium ion secondary battery includes an electrode group 4. The electrode group 4 includes a positive electrode 1, a negative electrode 2 disposed to face the positive electrode 1, and a porous separator (a porous insulating layer) 3 disposed between the positive electrode 1 and the negative electrode 2 to prevent direct contact of the positive electrode 1 to the negative electrode 2, wherein the positive electrode 1 and the negative electrode 2 are wound with the separator 3 interposed therebetween. The electrode group 4 is accommodated in a battery case 10 made of metal together with a nonaqueous electrolyte (not shown) which is conductive to lithium ions. In the battery case 10, the electrode group 4 is provided between an upper insulating plate 7 and a lower insulating plate 8, and the separator 3 is impregnated with the nonaqueous electrolyte. The battery case 10 has an opening sealed with a sealing plate 9 via an insulator.

The positive electrode 1 includes a positive electrode current collector 1A and a positive electrode active material layer 1B. The positive electrode current collector 1A is a plate or a foil having a high electrical conductivity, and is made of, for example, aluminum. The positive electrode active material layer 1B includes a positive electrode active material (e.g., nickel composite oxide), and is provided on a surface of the positive electrode current collector 1A such that a portion of the positive electrode current collector 1A in a longitudinal direction is exposed. Here, the positive electrode active material layer 1B may be provided on both surfaces of the positive electrode current collector 1A, or may be provided on one surface of the positive electrode current collector 1A. A positive electrode lead 5 made of, for example, aluminum is electrically connected to the portion of the surface of the positive electrode current collector 1A which is exposed from the positive electrode active material layer 1B (the exposed portion of the positive electrode current collector).

The positive electrode lead 5 is welded to the exposed portion of the positive electrode current collector 1A and the sealing plate 9. The positive electrode lead 5 extends from the exposed portion of the positive electrode current collector 1A to the outside of the positive electrode current collector 1A while straddling a first edge 11a, and further extends through a through hole 7a of the upper insulating plate 7 to the sealing plate 9. Note that the first edge 11a is any one of edges extending in a longitudinal direction of the positive electrode current collector 1A among edges of the exposed portion of the positive electrode current collector 1A. In FIG. 1, the first edge 11a is an upper edge of the positive electrode current collector 1A.

The negative electrode 2 includes a negative electrode current collector 2A and a negative electrode active material layer 2B. The negative electrode current collector 2A is a plate or a foil having a high electrical conductivity, and is made of, for example, copper. The negative electrode active material layer 2B includes a negative electrode active material (e.g., carbon), and is provided on a surface of the negative electrode current collector 2A such that a portion of the negative electrode current collector 2A in a longitudinal direction is exposed. Here, the negative electrode active material layer 2B may be provided on both surfaces of the negative electrode current collector 2A, or may be provided on one surface of the negative electrode current collector 2A. A negative electrode lead 6 made of, for example, nickel is electrically connected to a portion 21 of the surface of the negative electrode current collector 2A which is exposed from the negative electrode active material layer 2B (the exposed portion of the negative electrode current collector).

The negative electrode lead 6 is welded to the exposed portion 21 of the negative electrode current collector 2A and a center portion of a bottom surface of the battery case 10. The negative electrode lead 6 extends from the exposed portion 21 of the negative electrode current collector 2A to the outside of the negative electrode current collector 2A while straddling a first edge 21a, is bend at a border between an inner side surface and the bottom surface of the battery case 10, and further extends to the center of the bottom surface along the bottom surface of the battery case 10. Note that the first edge 21a is any one of edges extending in a longitudinal direction of the negative electrode current collector 2A among edges of the exposed portion 21 of the negative electrode current collector 2A. In FIG. 1, the first edge 21a is a lower edge of the negative electrode current collector 2A.

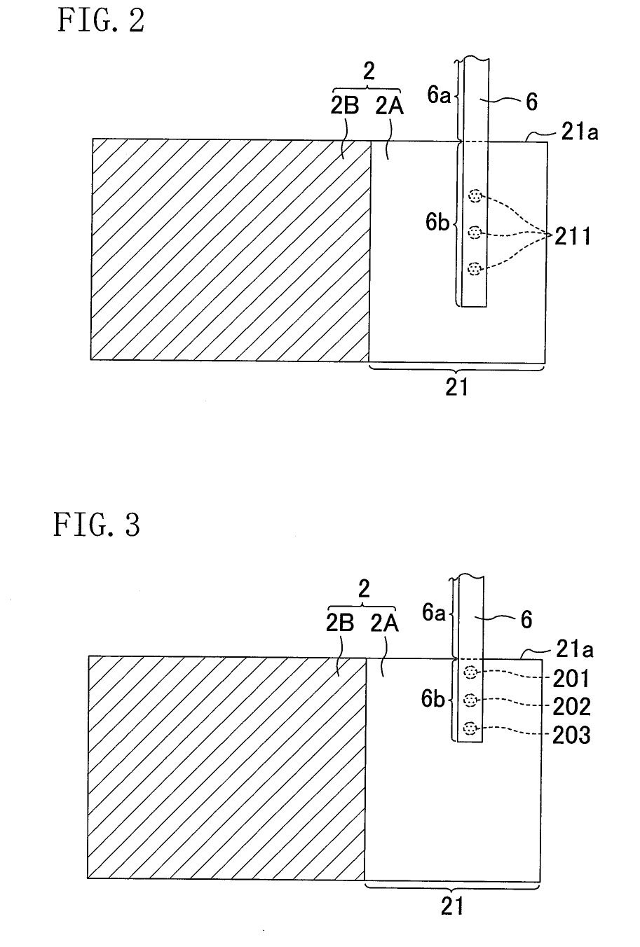

When an external short circuit occurs in the lithium ion secondary battery according to the present embodiment, significant heat will be generated at the negative electrode lead 6 since the resistance of the negative electrode lead 6 is higher than that of the positive electrode lead 5. As described above, the negative electrode lead 6 is welded to the exposed portion 21 of the negative electrode current collector 2A, and to the bottom surface of the battery case 10. According to the above results of the studies, most of the heat generated at the negative electrode lead 6 is released to the negative electrode current collector 2A at welding points of the negative electrode lead 6 to the exposed portion 21 of the negative electrode current collector 2A, and is released to the battery case 10 at welding points of the negative electrode lead 6 to the battery case 10 (it can be expected that some of the heat generated at the negative electrode lead 6 is released to the negative electrode current collector 2A or to the nonaqueous electrolyte in the periphery of the negative electrode current collector 2A at non-welding points between the negative electrode lead 6 and the exposed portion 21 of the negative electrode current collector 2A, and is released to the battery case 10 or to the nonaqueous electrolyte in the periphery of the battery case 10 at non-welding points between the negative electrode lead 6 and the battery case 10). The welding points of the negative electrode lead 6 to the exposed portion 21 of the negative electrode current collector 2A will be described below with reference to FIGS. 2 and 3 in comparison to a conventional configuration. Both FIGS. 2 and 3 are plan views each illustrating a state in which the negative electrode lead 6 is welded to the exposed portion 21 of the negative electrode current collector 2A, wherein FIG. 2 illustrates a conventional configuration, and FIG. 3 illustrates the present embodiment.

As shown in FIG. 2, the negative electrode lead 6 is conventionally welded to the exposed portion 21 of the negative electrode current collector 2A at a plurality of points, and welding points 211 each have an area larger than or equal to a certain area. Therefore, it is possible to ensure the weld strength of the negative electrode lead 6 to the exposed portion 21 of the negative electrode current collector 2A, and it is further possible to ensure electrical conductivity between the negative electrode lead 6 and the negative electrode current collector 2A. As described above, it has conventionally been considered that the negative electrode lead 6 may be welded to the exposed portion 21 of the negative electrode current collector 2A so that the weld strength of the negative electrode lead 6 to the exposed portion 21 of the negative electrode current collector 2A can be ensured, and the electrical conductivity between the negative electrode lead 6 and the negative electrode current collector 2A can be ensured. Note that a welding method is not limited to, for example, resistance welding or ultrasonic welding, but a known welding method can be used. Moreover, the negative electrode current collector and the negative electrode lead may be joined to each other by crimping.

In contrast, in the present embodiment, as illustrated in FIG. 3, the negative electrode lead 6 is welded to the exposed portion 21 of the negative electrode current collector 2A at a position closer to the first edge 21a of the negative electrode current collector 2A in comparison to conventional configurations. In other words, the negative electrode lead 6 is welded to the exposed portion 21 of the negative electrode current collector 2A at a position closer to a first portion 6a in comparison to conventional configurations. In other words, the distance between the first portion 6a and welding points 201, 202, 203 of the negative electrode lead 6 to the exposed portion 21 of the negative electrode current collector 2A is shorter in comparison to conventional configurations. Thus, in the present embodiment, even if significant heat is generated at the negative electrode lead 6 due to an external short circuit, the heat can be moved from the first portion 6a to the welding points 201, 202, 203 of the negative electrode lead 6 to the exposed portion 21 of the negative electrode current collector 2A more rapidly than in conventional configurations. Therefore, in the present embodiment, the heat can be released to the negative electrode current collector 2A more rapidly than in conventional configurations. In this way, it is possible to prevent the heat generated at the negative electrode lead 6 from remaining at the first portion 6a.

The closer to the first edge 21a of the negative electrode current collector 2A the welding points of the negative electrode lead 6 to the exposed portion 21 of the negative electrode current collector 2A are, the more rapidly the heat generated at the negative electrode lead 6 can be released to the negative electrode current collector 2A. However, when the welding points are too close to the first edge 21a of the negative electrode current collector 2A, it is difficult to weld the negative electrode lead 6 to the exposed portion 21 of the negative electrode current collector 2A with a strength higher than or equal to a certain level. Even if the negative electrode lead 6 could be welded to the negative electrode current collector 2A with a strength higher than or equal to a certain level, the welding of the negative electrode lead 6 to the exposed portion 21 of the negative electrode current collector 2A has to be performed after precisely setting the position at which the negative electrode lead 6 is welded to the exposed portion 21 of the negative electrode current collector 2A, and thus it takes time to weld the negative electrode lead 6 to the exposed portion 21 of the negative electrode current collector 2A. Taking the above facts into consideration, the negative electrode lead 6 is welded to the exposed portion 21 of the negative electrode current collector 2A preferably at a position 5 mm or less away from the first edge 21a of the negative electrode current collector 2A, and more preferably at a position greater than or equal to 0.1 mm and less than or equal to 3 mm away from the first edge 21a of the negative electrode current collector 2A. For example, the negative electrode lead has conventionally been welded to the exposed portion of the negative electrode current collector at a position 8 mm or more away from the first edge of the negative electrode current collector.

In practice, the negative electrode lead 6 is welded to the exposed portion 21 of the negative electrode current collector 2A at a plurality of points in order to ensure the weld strength of the negative electrode lead 6 to the exposed portion 21 of the negative electrode current collector 2A. In the present embodiment, the negative electrode lead 6 is welded to the exposed portion 21 of the negative electrode current collector 2A at three points as illustrated in FIG. 3. In the present description, for the sake of convenience, a welding point located closest to the first edge 21a of the negative electrode current collector 2A is defined as the first welding point 201, and welding points are sequentially defined as the second welding point 202 and the third welding point 203 as their distances from the first edge 21a of the negative electrode current collector 2A increase. The inventors of the present application investigated the degree of heat release at every welding point, and confirmed that most of the heat generated at the negative electrode lead 6 was released at the first welding point 201 to the negative electrode current collector 2A. Therefore, in the negative electrode 2 of the present embodiment, the first welding point 201 may be arranged closer to the first edge 21a of the negative electrode current collector 2A in comparison to conventional configurations. Specifically, it is preferable that the first welding point 201 is equal to or less than 5 mm away from the first edge 21a of the negative electrode current collector 2A. It is more preferable that the first welding point 201 is greater than or equal to 0.1 mm and less than or equal to 3 mm away from the first edge 21a of the negative electrode current collector 2A. Welding points such as the second welding point 202 and the third welding point 203 other than the first welding point 201 may be arranged at the same positions as in conventional configurations, may be arranged at a position closer to the first edge 21a of the negative electrode current collector 2A in comparison to the conventional configurations, or may be arranged at a position further away from the first edge 21a of the negative electrode current collector 2A in comparison to the conventional configuration.

As described above, when the negative electrode lead 6 is welded to the exposed portion 21 of the negative electrode current collector 2A at a position closer to the first edge 21a of the negative electrode current collector 2A in comparison to conventional configurations, it is possible to rapidly release the heat generated at the negative electrode lead 6 to the negative electrode current collector 2A. Moreover, since the negative electrode lead 6 is made of nickel, it is possible to ensure the weld strength of the negative electrode lead 6 to the exposed portion 21 of the negative electrode current collector 2A and to the battery case 10. Furthermore, it is possible to obtain two advantages described below.

A first advantage is that the price of the lithium ion secondary battery can be lowered while increasing the capacity of the lithium ion secondary battery. When the negative electrode lead 6 is welded to the exposed portion 21 of the negative electrode current collector 2A at a position closer to the first edge 21a of the negative electrode current collector 2A in comparison to conventional configurations, in other words, when the distance between the first welding point 201 and the first edge 21a of the negative electrode current collector 2A is shorter than that in the conventional configurations, the length of a portion of the negative electrode lead 6 which abuts the exposed portion 21 of the negative electrode current collector 2A can be shorter than that in the conventional configurations. For example, the length of the portion of the negative electrode lead 6 which abuts the exposed portion 21 of the negative electrode current collector 2A can be equal to or less than ⅓ of the length of the negative electrode current collector 2A in its width direction (a longitudinal direction of the negative electrode lead 6). Thus, the length of the negative electrode lead 6 can be shorter than that in conventional configurations. This makes it possible to lower the cost of the lithium ion secondary battery. Moreover, when the length of the portion of the negative electrode lead 6 which abuts the exposed portion 21 of the negative electrode current collector 2A is shorter than that in conventional configurations, an increase of the volume of the electrode group 4 can be prevented, so that it is possible to increase the filling quantity of the active material. Therefore, it is possible to increase the capacity of the lithium ion secondary battery.

A second advantage is that the safety of a high-capacity, high-power lithium ion secondary battery can be ensured, and the safety of the high-capacity, high-power lithium ion secondary battery can be ensured even when an external short circuit of the high-capacity, high-power lithium ion secondary battery occurs. When the capacity and the power of the lithium ion secondary battery are increased, the lithium ion secondary battery conducts a large current, so that the large current flows through the negative electrode lead regardless of the occurrence of the external short circuit. Even in such a high-capacity, high-power lithium ion secondary battery, it is possible to rapidly release the heat generated at the negative electrode lead 6 to the negative electrode current collector 2A when the negative electrode lead 6 is welded to the exposed portion 21 of the negative electrode current collector 2A at a position closer to the first edge 21a of the negative electrode current collector 2A in comparison to conventional configurations. Therefore, it is possible to ensure the safety of the high-capacity, high-power lithium ion secondary battery.

Moreover, when an external short circuit of the high-capacity, high-power lithium ion secondary battery occurs, a much larger current flows through the negative electrode lead in comparison to the case where no external short circuit of the high-capacity, high-power lithium ion secondary battery occurs. Even in this case, it is possible to rapidly release the heat generated at the negative electrode lead 6 to the negative electrode current collector 2A when the negative electrode lead 6 is welded to the exposed portion 21 of the negative electrode current collector 2A at a position closer to the first edge 21a of the negative electrode current collector 2A in comparison to conventional configurations. Therefore, even when an external short circuit of the high-capacity, high-power lithium ion secondary battery occurs, it is possible to ensure the safety of the high-capacity, high-power lithium ion secondary battery.

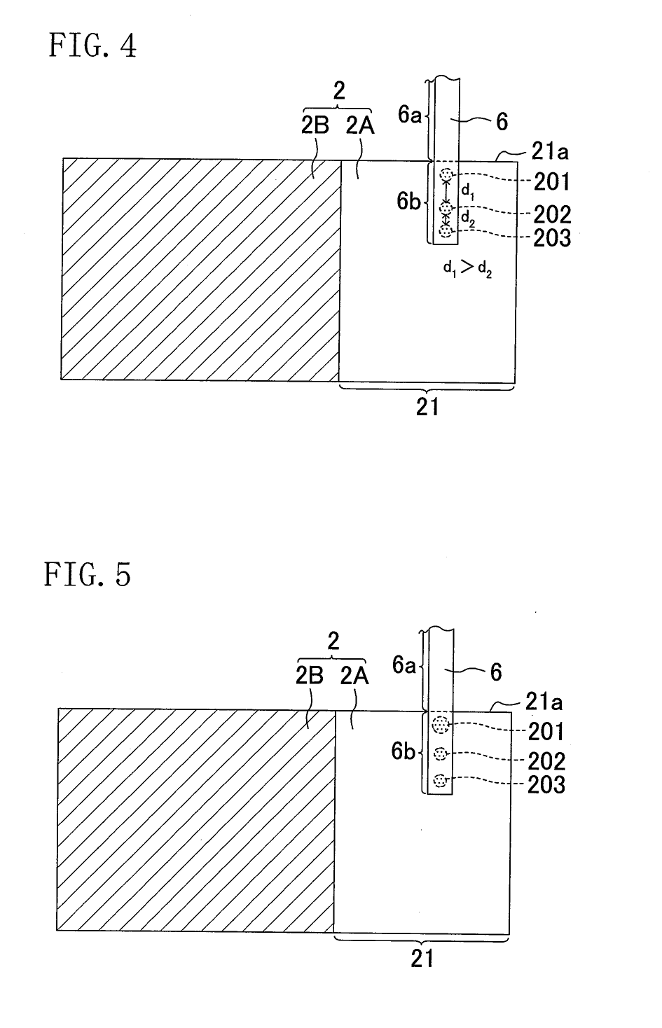

The distance between the first welding point 201 and the first edge 21a of the negative electrode current collector 2A is preferably 5 mm or less, but the interval between the adjacent welding points (e.g., the interval between the first welding point 201 and the second welding point 202) is not limited to a particular length. The first welding point 201, the second welding point 202, and the third welding point 203 may be disposed at even intervals to each other as in conventional configurations. Alternatively, when the second welding point 202 and the third welding point 203 are disposed at the same positions as in conventional configurations, and the first welding point 201 is disposed at a position closer to the first edge 21a of the negative electrode current collector 2A in comparison to the conventional configurations, the distance (d₁) between the first welding point 201 and the second welding point 202 is larger than the distance (d₂) between the second welding point 202 and the third welding point 203 as shown in FIG. 4.

Each of the welding points may have such an area that the weld strength of the negative electrode lead 6 to the exposed portion 21 of the negative electrode current collector 2A can be ensured, and that the electrical conductivity between the negative electrode lead 6 and the negative electrode current collector 2A can be ensured. However, when attention is drawn to the fact that most of the heat generated at the negative electrode lead 6 is released to negative electrode current collector 2A at the first welding point 201, the first welding point 201 is preferably larger than each of the welding points (the second welding point 202 and the third welding point 203) other than the first welding point 201 as shown in FIG. 5. In this configuration, it is possible to release the heat generated at the negative electrode lead 6 to the negative electrode current collector 2A more rapidly than in the case where the welding points have the same area. Moreover, when the welding point has a large area, the resistance at the welding point can be reduced, so that it is possible to limit Joule's heat generated at the first welding point 201 to a low quantity. Specifically, the first welding point 201 may have an area of 2 mm² or larger.

As described above, in the lithium ion secondary battery according to the present embodiment, it is possible to rapidly release heat to the negative electrode current collector 2A even when the heat is generated at the negative electrode lead 6 due to the occurrence of an external short circuit. Thus, in the present embodiment, the negative electrode lead 6 can be prevented from having a portion which has a very high temperature when an external short circuit occurs, so that it is possible to ensure the safety in the case of the occurrence of the external short circuit.

Moreover, in the lithium ion secondary battery according to the present embodiment, the negative electrode lead 6 is made of nickel, so that it is possible to ensure the weld strength of the negative electrode lead 6 to the exposed portion 21 of the negative electrode current collector 2A and to the battery case 10. That is, in the lithium ion secondary battery according to the present embodiment, it is possible to ensure the safety in the case of the occurrence of the external short circuit while ensuring the weld strength of the negative electrode lead 6 to the exposed portion 21 of the negative electrode current collector 2A and to the battery case 10.

Moreover, in the lithium ion secondary battery according to the present embodiment, the negative electrode lead 6 is welded to the exposed portion 21 of the negative electrode current collector 2A at a position closer to the first edge 21a of the negative electrode current collector 2A in comparison to conventional configurations, so that it is possible to shorten the negative electrode lead 6. Thus, the present embodiment can provide low-cost, high-capacity lithium ion secondary batteries.

In addition, in the lithium ion secondary battery according to the present embodiment, the negative electrode lead 6 can be prevented from having a portion which has a very high temperature when a large current is conducted through the negative electrode lead 6, so that it is possible to ensure the safety of the high-capacity, high-power lithium ion secondary battery. Moreover, even when an external short circuit of the high-capacity, high-power lithium ion secondary battery occurs, it is possible to rapidly release the heat generated at the negative electrode lead 6 to the negative electrode current collector 2A. As described above, welding the negative electrode lead 6 to the exposed portion 21 of the negative electrode current collector 2A at a position closer to the first edge 21a of the negative electrode current collector 2A in comparison to conventional configurations is effective when applied to the high-capacity, high-power lithium ion secondary battery.

Although the battery according to the present embodiment has been described above, it can be contemplated that advantages similar to those described in the present embodiment can be obtained when the negative electrode lead 6 is welded to the bottom surface of the battery case 10 at a position closer to the first portion 6a in comparison to conventional configurations. However, a welding rod (not shown) is inserted in a cavity of the electrode group 4 and in a through hole 8a of the lower insulating plate 8, and using the welding rod, the negative electrode lead 6 is welded to the bottom surface of the battery case 10. Therefore, it is difficult to shift the welding points of the negative electrode lead 6 to the bottom surface of the battery case 10 to a position close to the first portion 6a.

Materials for the positive electrode current collector 1A, the positive electrode active material layer 1B, the separator 3, the nonaqueous electrolyte, the negative electrode current collector 2A, and the negative electrode active material layer 2B will be described in turn below.

As a material for the positive electrode current collector 1A, aluminum (Al), carbon, or an conductive resin can be used. When aluminum or a conductive resin is used as the material for the positive electrode current collector 1A, a surface of the positive electrode current collector 1A may be treated with carbon.

The positive electrode active material layer 1B includes a positive electrode active material. As the positive electrode active material, LiCoO₂, LiNiO₂, or Li₂MnO₄ may be used as a simple substance, or two or more of the substances mentioned above may be used, that is, a lithium-containing composite oxide may be used. Examples of the lithium-containing composite oxide includes olivine-type lithium phosphate expressed by the general formula LiM₁PO₄ (M₁=V, Fe, Ni, Mn), and lithium fluorophosphate expressed by the general formula Li₂M₂PO₄F (M₂=V, Fe, Ni, Mn) in addition to LiCoO₂, LiNiO₂, and Li₂MnO₄. Moreover, as the positive electrode active material, a material obtained by substituting some of the metallic elements constituting the lithium-containing composite oxide with other metallic elements may be used. Furthermore, as the positive electrode active material, a material obtained by treating the surface of the lithium-containing composite oxide with, for example, a metal oxide, a lithium oxide, or a conductive agent, or a material obtained by subjecting the lithium-containing composite oxide to hydrophobic treatment may be used.

The positive electrode active material layer 1B includes a conductive agent and a binder in addition to the positive electrode active material. As the conductive agent, graphites such as natural graphite and artificial graphite; carbon blacks such as acetylene black, ketjen black, channel black, furnace black, lamp black, and thermal black; conductive fibers such as carbon fibers and metal fibers; fluorocarbon; powder of metal such as aluminum; conductive whiskers such as zinc oxide and potassium titanate; a conductive metal oxide such as titanium oxide; or an organic conductive material such as a phenylene derivative can be used.

As the binder, a polymer such as poly(vinylidene fluoride) (PVDF), polytetrafluoroethylene, polyethylene, polypropylene, an aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyethersulfone, hexafluoropolypropylene, styrene butadiene rubber, and carboxymethylcellulose can be used. As the binder, a copolymer including two or more materials selected from the group consisting of tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene can also be used. As the binder, a mixture of two or more materials selected from the above polymers and the above copolymers can also be used.

As the nonaqueous electrolyte, an electrolyte solution obtained by dissolving a solute in an organic solvent, or a so-called polymer electrolyte obtained by bringing an electrolyte solution into a gel state with macromolecules can be used. At least when the electrolyte solution is used as the nonaqueous electrolyte, it is preferable that the separator 3 which is, for example, non-woven fabric or a microporous film made of polyethylene, polypropylene, an aramid resin, amideimide, polyphenylene sulfide, polyimide, or the like is provided between the positive electrode 1 and the negative electrode 2, and the separator is impregnated with the electrolyte solution. Moreover, a heat resistant member such as alumina, magnesia, silica, and titania may be provided in the separator 3 or on a surface of the separate 3. A heat resistant layer including the heat resistant member mentioned above, and a binder which is the same as that provided on the positive electrode 1 and the negative electrode 2 may be provided in addition to the separator 3.

A material for the nonaqueous electrolyte is selected based on, for example, the oxidation-reduction potential of each active material. As a solute preferable for the nonaqueous electrolyte, LiPF₆, LiBF₄, LiClO₄, LiAlCl₄, LiSbF₆, LiSCN, LiCF₃SO₃, LiNCF₃CO₂, LiAsF₆, LiB₁₀Cl₁₀, lower aliphatic series lithium carboxylate, LiF, LiCl, LiBr, LiI, chloroborane lithium, borate salts such as bis(1,2-benzenediolate(2-)-O,O′)lithium borate, bis(2,3-naphthalenediolate(2-)-O,O′)lithium borate, bis(2,2′-biphenyl diolate(2-)-O,O′)lithium borate, and bis(5-fluoro-2-olate-1-benzenesulfonate-O,O′)lithium borate, (CF₃SO₂)₂NLi, LiN(CF₃SO₂)(C₄F₉SO₂), (C₂F₅SO₂)₂NLi, tetraphenyllithium borate, or the like can be used, that is, salts generally used for lithium ion secondary batteries can be used.

Moreover, as an organic solvent in which the salt mentioned above is dissolved, for example, one of, or a mixture including two or more of ethylene carbonate (EC), propylene carbonate, butylene carbonate, vinylene carbonate, dimethyl carbonate (DMC), diethyl carbonate, ethyl methyl carbonate (EMC), dipropyl carbonate, methyl formate, methyl acetate, methyl propionate, ethyl propionate, dimethoxymethane, γ-butyrolactone, γ-valerolactone, 1,2-diethoxyethane, 1,2-dimethoxyethane, ethoxymethoxyethane, trimethoxymethane, tetrahydrofuran, a tetrahydrofuran derivative (e.g., 2-methyltetrahydrofuran), dimethyl sulfoxide, a dioxolane derivative (e.g., 1,3-dioxolane and 4-methyl-1,3-dioxolane), formamide, acetamide, dimethylformamide, acetonitrile, propylnitrile, nitromethane, ethyl monoglyme, phosphoric triester, acetic ester, propionate, sulfolane, 3-methyl sulfolane, 1,3-dimethyl-2-imidazolidinone, 3-methyl-2-oxazolidinone, a propylene carbonate derivative, ethyl ether, diethyl ether, 1,3-propane sultone, anisole, fluorobenzene, and the like can be sued, that is, a solvent generally used for lithium ion secondary batteries can be used.

Moreover, the organic solvent in which the salt mentioned above is dissolved may contain an additive agent such as vinylene carbonate, cyclohexylbenzene, biphenyl, diphenyl ether, vinylethylene carbonate, divinylethylene carbonate, phenylethylene carbonate, diallyl carbonate, fluoroethylene carbonate, catechol carbonate, vinyl acetate, ethylene sulfite, propane sultone, trifluoropropylene carbonate, dibenzofuran, 2,4-difluoroanisole, o-terphenyl, m-terphenyl, or the like.

Moreover, as the nonaqueous electrolyte, a solid electrolyte obtained by mixing the solute mentioned above with one of, or a mixture including two or more of macromolecular materials such as polyethylene oxide, polypropylene oxide, polyphosphazene, polyaziridine, polyethylene sulfide, polyvinyl alcohol, polyvinylidene fluoride, polyhexafluoropropylene, and the like can also be used. Further, as the nonaqueous electrolyte, a gel obtained by mixing the organic solvent mentioned above with the macromolecular material mentioned above can also be used. Furthermore, an inorganic material such as lithium nitride, lithium halide, lithium oxysalt, Li₄SiO₄, Li₄SiO₄—LiI—LiOH, Li₃PO₄—Li₄SiO₄, Li₂SiS₃, Li₃PO₄—Li₂S—SiS₂, a phosphorus sulfide compound, and the like may be used as the solid electrolyte. When a gel nonaqueous electrolyte is used as the nonaqueous electrolyte, the gel nonaqueous electrolyte may be provided between the positive electrode 1 and the negative electrode 2 instead of the separator 3, or may be provided to be adjacent to the separator 3.

As the negative electrode current collector 2A, a metal foil made of, for example, stainless steel, nickel, copper, or titanium may be used, or a thin film made of, for example, carbon, or a conductive resin may be used. Moreover, a surface of the metal foil or the thin film may be treated with, for example, carbon, nickel, or titanium.

The negative electrode active material layer 2B includes a negative electrode active material. As the negative electrode active material, carbon material (e.g., various kinds of natural graphite or artificial graphite), a substance containing Si (e.g., Si as a simple substance, a Si alloy, SiOₓ (0<x<2), or the like), a substance containing Sn (e.g., Sn as a simple substance, a Sn alloy, SnO, or the like), a lithium metal, or the like can be used. The lithium metal includes a lithium alloy containing Al, Zn, Mg, or the like in addition to lithium as a simple substance. As the negative electrode active material, one of the above substances may be used alone, or two or more of the above substances may be used in combination.

The negative electrode active material layer 2B includes a binder in addition to the negative electrode active material. As the binder, the same material as that for the binder contained in the positive electrode active material layer can be used.

### Second Embodiment of the Invention

In a battery according to a second embodiment, the resistance of a positive electrode lead 5 is higher than that of a negative electrode lead 6.

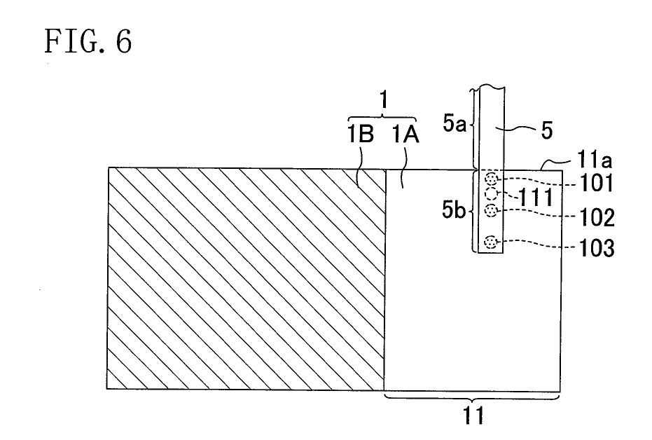

FIG. 6 is a plan view illustrating a state in which the positive electrode lead 5 is welded to an exposed portion 11 of a positive electrode current collector 1A of the present embodiment.

The positive electrode lead 5 of the present embodiment is welded to the exposed portion 11 of the positive electrode current collector 1A at a position closer to a first edge 11a of the positive electrode current collector 1A in comparison to conventional configurations. In other words, the positive electrode lead 5 is welded to the exposed portion 11 of the positive electrode current collector 1A at a position closer to a first portion 5a in comparison to conventional configurations.

When an external short circuit of a lithium ion secondary battery of the present embodiment occurs, heat is generated at the positive electrode lead 5 and the negative electrode lead 6. In the present embodiment, since the resistance of the positive electrode lead 5 is higher than that of the negative electrode lead 6, significant heat should be generated at the positive electrode lead 5. However, in the present embodiment, the positive electrode lead 5 is welded to the exposed portion 11 of the positive electrode current collector 1A at a position closer to the first portion 5a in comparison to conventional configurations. Thus, even if the significant heat is generated at the positive electrode lead 5 due to the external short circuit, the heat can move from the first portion 5a to welding points 101, 102, 103 of the positive electrode lead 5 to the exposed portion 11 of the positive electrode current collector 1A more rapidly than in conventional configurations, so that it is possible to release the heat to the positive electrode current collector 1A more rapidly than in the conventional configurations. In this way, it is possible to prevent the heat generated at the positive electrode lead 5 from remaining at the first portion 5a.

In the present embodiment, most of the heat generated at the positive electrode lead 5 is released to the positive electrode current collector 1A at the welding point (first welding point) 101 located closest to the first edge 11 a among the welding points 101, 102, 103 of the positive electrode lead 5 to the exposed portion 11 of the positive electrode current collector 1A as in the first embodiment. Thus, the distance from the first welding point 101 to the first edge 11 a, the intervals between the welding points adjacent to each other, and the area of each of the welding points may be as described in the first embodiment. That is, the first welding point 101 is located closer to the first edge 11a in comparison to a first welding point 111 of a conventional configuration, is preferably 5 mm or less away from the first edge 11a, and is more preferably greater than or equal to 0.1 mm and less than or equal to 3 mm away from the first edge 11a. Moreover, the intervals between the adjacent welding points may be equal to each other, or the interval between the first welding point 101 and the second welding point 102 may be larger than the interval between the second welding point 102 and the third welding point 103. Furthermore, the welding points may have the same area, or the first welding point 101 may have the largest area.

### Other Embodiments

The first and second embodiments may each have a configuration described below.

Although the examples of the present invention applied to the cylindrical, wound lithium ion secondary batteries have been described in the first and the second embodiments, the present invention is applicable to square lithium ion secondary batteries. When an external short circuit of a square lithium ion secondary battery occurs, heat generated at a lead should remain most likely at a portion of the lead which does not abut an exposed portion of a current collector and an electrode terminal. Therefore, the lead may be welded to the current collector at a position closer to a first edge of the current collector in comparison to conventional configurations. Note that in an electrode group provided in the square lithium ion secondary battery, a positive electrode and a negative electrode may be wound with a separator provided therebetween, or the positive electrodes and the negative electrodes may be stacked on one another with the separator provided therebetween.

In the positive electrode of the first and second embodiments, the positive electrode current collector may have two or more exposed portions, and positive electrode leads may be welded respectively to the exposed portions of the positive electrode current collector. Likewise, in the negative electrode, the negative electrode current collector may have two or more exposed portions, and negative electrode leads may be welded respectively to the exposed portions of the negative electrode current collector.

The positive electrode lead of the first embodiment may be welded to the exposed portion of the positive electrode current collector at substantially the same position as in conventional configurations, or may be welded, as described in the second embodiment, to the exposed portion of the positive electrode current collector at a position closer to the first edge of the positive electrode current collector in comparison to the conventional configurations. The safety of the battery at the occurrence of an external short circuit can be ensured more in the latter case than in the former case.

Likewise, the negative electrode lead of the second embodiment may be welded to the exposed portion of the negative electrode current collector at substantially the same position as in conventional configurations, or may be welded, as described in the first embodiment, to the exposed portion of the negative electrode current collector at a position closer to the first edge of the negative electrode current collector in comparison to the conventional configurations. The safety of the battery at the occurrence of an external short circuit can be ensured more in the latter case than in the former case.

### Examples

The present invention will be specifically described below with reference to examples. The description here is not to limit but only to exemplify the present invention.

Method for Fabricating Lithium Ion Secondary Battery

### First Example

(a) Formation of Positive Electrode

Using a twin-arm kneader, 3 kg of lithium cobaltate (a positive electrode active material), 1 kg of “#1320 (product name)” (an N-methylpyrrolidone (NMP) solution containing 12% by weight of PVDF: a binder of a positive electrode) manufactured by Kureha Corporation, 90 g of acetylene black (a conductive agent), and a proper amount of NMP were stirred. In this way, positive electrode mixture slurry was prepared.

The positive electrode mixture slurry was applied to both surfaces of an aluminum foil (15 μm in thickness: a positive electrode current collector). At this time, a portion of the aluminum foil to which a positive electrode lead was supposed to be welded (an exposed portion of the positive electrode current collector) was not coated with the positive electrode mixture slurry. The positive electrode mixture slurry was dried, thereby obtaining a layered product in which the both surfaces of the aluminum foil were coated with the positive electrode mixture slurry. The layered product was rolled by a roller, thereby forming a positive electrode plate in which positive electrode mixture layers were formed on the both surfaces of the aluminum foil. Note that when rolling, the thickness of the positive electrode plate was controlled to be 160 μm.

After that, the formed positive electrode plate was cut to have a width (56 mm) capable of being inserted into a battery case of a cylindrical battery (18 mm in diameter, 65 mm in length), thereby forming a positive electrode. Then, on the portion of the aluminum foil to which the positive electrode lead was supposed to be welded, the positive electrode lead (3 mm in width, 0.1 mm in thickness) made of aluminum was disposed such that 50 mm of the positive electrode lead lay thereon. Then, using an electrode rod (3 mm² in area: this area was supposed to be the area of each of welding points), the positive electrode lead was welded to the aluminum foil at positions respectively 5 mm, 20 mm, and 35 mm away from a first edge of the positive electrode current collector.

(b) Formation of Negative Electrode

Using a twin-arm kneader, 3 kg of artificial graphite (a negative electrode active material), 75 g of “BM-400B (product name)” (aqueous dispersion containing 40% by weight of a modified styrene-butadiene copolymer: a binder of a negative electrode) manufactured by Zeon Corporation, 30 g of carboxymethyl cellulose (CMC: a viscosity bodying agent), and a proper amount of water were stirred. In this way, negative electrode mixture slurry was prepared.

The negative electrode mixture slurry was applied to both surfaces of a copper foil (10 μm in thickness: a negative electrode current collector). At this time, a portion of the copper foil to which a negative electrode lead was supposed to be welded (an exposed portion of the negative electrode current collector) was not coated with the negative electrode mixture slurry. The negative electrode mixture slurry was dried, thereby obtaining a layered product in which the both surfaces of the copper foil were coated with the negative electrode mixture slurry. The layered product was rolled by a roller, thereby forming a negative electrode plate in which negative electrode mixture layers were formed on the both surfaces of the copper foil. Note that when rolling, the thickness of the negative electrode plate was controlled to be 180 μm.

After that, the formed negative electrode plate was cut to have a width (57 mm) capable of being inserted into the battery case of the cylindrical battery, thereby forming a negative electrode. Then, on the portion of the copper foil to which the negative electrode lead was supposed to be welded, the negative electrode lead (3 mm in width, 0.1 mm in thickness) made of nickel was disposed such that 50 mm of the negative electrode lead lay thereon. Then, using an electrode rod (3 mm² in area: this area was supposed to be the area of each of welding points), the negative electrode lead was welded to the nickel foil at positions respectively 1 mm, 17.3 mm, and 33.7 mm away from a first edge of the negative electrode current collector.

(c) Preparation of Nonaqueous Electrolyte

In a mixture of a nonaqueous solvent containing ethylene carbonate (EC) and ethyl methyl carbonate (EMC) in a volume ratio of 3:7, LiPF₆ was dissolved at a concentration of 1 mol/L. Three parts by weight of vinylene carbonate (VC) was added to every 100 parts by weight of the obtained solution, thereby obtaining a nonaqueous electrolyte.

(d) Fabrication of Battery

A cylindrical battery was fabricated as described below.

The positive electrode and the negative electrode were disposed with a microporous film made of polyethylene having a thickness of 20 μm (manufactured by Asahi Kasei Corporation) therebetween, and the positive electrode, the separator, and the negative electrode were wound such that the positive electrode lead was disposed at an inner peripheral side, and the negative electrode lead was disposed at an outer peripheral side. In this way, a cylindrical electrode group was formed.

Next, a lower insulating plate was disposed to lie on a bottom portion of the electrode group, and the electrode group was inserted into the battery case. An upper insulating plate was disposed on the inserted electrode group. The other end of the negative electrode lead (the end of the negative electrode lead which was not welded to the exposed portion of the negative electrode current collector) was welded to a bottom surface of the battery case, and then the battery case was processed to have a recess.

Next, 5 g of the nonaqueous electrolyte was poured into the battery case. After that, the electrode group was impregnated with the nonaqueous electrolyte. That is, the electrode group was left under a low pressure of 133 Pa until no residue of the nonaqueous electrolyte could be observed on a surface of the electrode group.

Next, the other end of the positive electrode lead (the end of the positive electrode lead which was not welded to the exposed portion of the positive electrode current collector) was welded to a lower surface of a sealing plate.

After that, the sealing plate was inserted into the battery case, and a cylindrical lithium ion secondary battery was completed by crimp molding. The design capacity of the battery was 2200 mAh.

### Second Example

A lithium ion secondary battery was fabricated in the same manner as in the first example except that a negative electrode lead was welded to a nickel foil at positions respectively 2 mm, 18 mm, and 34 mm away from a first edge of a negative electrode current collector.

### Third Example

A lithium ion secondary battery was fabricated in the same manner as in the first example except that a negative electrode lead was welded to a nickel foil at positions respectively 3 mm, 18.7 mm, and 34.3 mm away from a first edge of a negative electrode current collector.

### Fourth Example

A lithium ion secondary battery was fabricated in the same manner as in the first example except that a negative electrode lead was welded to a nickel foil at positions respectively 4 mm, 19.3 mm, and 34.7 mm away from a first edge of a negative electrode current collector.

### Fifth Example

A lithium ion secondary battery was fabricated in the same manner as in the first example except that a negative electrode lead was welded to a nickel foil at positions respectively 5 mm, 20 mm, and 35 mm away from a first edge of a negative electrode current collector.

### First Comparative Example

A lithium ion secondary battery was fabricated in the same manner as in the first example except that a negative electrode lead was welded to a nickel foil at positions 8 mm, 22 mm, and 36 mm away from a first edge of a negative electrode current collector.

### Second Comparative Example

A lithium ion secondary battery was fabricated in the same manner as in the first example except that a negative electrode lead was welded to a nickel foil at positions 10 mm, 23.3 mm, and 36.7 mm away from a first edge of a negative electrode current collector.

### Third Comparative Example

A lithium ion secondary battery was fabricated in the same manner as in the first example except that a negative electrode lead was welded to a nickel foil at positions 15 mm, 26.7 mm, and 38.3 mm away from a first edge of a negative electrode current collector.

### Sixth Example

A lithium ion secondary battery was fabricated in the same manner as in the third example except that the area of an electrode rod used to weld an negative electrode lead to a negative electrode current collector (the area was supposed to be the area of each of welding points) was 1 mm².

### Seventh Example

A lithium ion secondary battery was fabricated in the same manner as in the third example except that the area of an electrode rod used to weld an negative electrode lead to a negative electrode current collector (the area was supposed to be the area of each of welding points) was 1.7 mm².

### Eighth Example

A lithium ion secondary battery was fabricated in the same manner as in the third example except that the area of an electrode rod used to weld an negative electrode lead to a negative electrode current collector (the area was supposed to be the area of each of welding points) was 2 mm².

### Ninth Example

A lithium ion secondary battery was fabricated in the same manner as in the third example except that the area of an electrode rod used to weld an negative electrode lead to a negative electrode current collector (the area was supposed to be the area of each of welding points) was 2.5 mm².

Evaluation of Lithium Ion Secondary Battery

The batteries of the examples 1-9 and the comparative examples 1-3 were evaluated as follows.

The batteries were charged to 4.1 V with a current value of 400 mA after two preliminary charge/discharge cycles. After that, the charged batteries were stored for 7 days under an environment at 45° C.

The thus fabricated batteries were charged under an environment at 20° C. under the following conditions.

Constant current charge: charging current value 1500 mA, charge-end voltage 4.2 V

Constant voltage charge: charging voltage value 4.2 V, charge-end current 100 mA

Constant current discharge: discharging current value 2200 mA, discharge-end voltage 3 V

After that, under an environment at 20° C., a short circuit was formed between a positive electrode terminal and a negative electrode terminal of the battery by using an external circuit having a resistance of about 5 mΩ. Then, the temperature of the battery was measured three seconds after the occurrence of the short circuit.

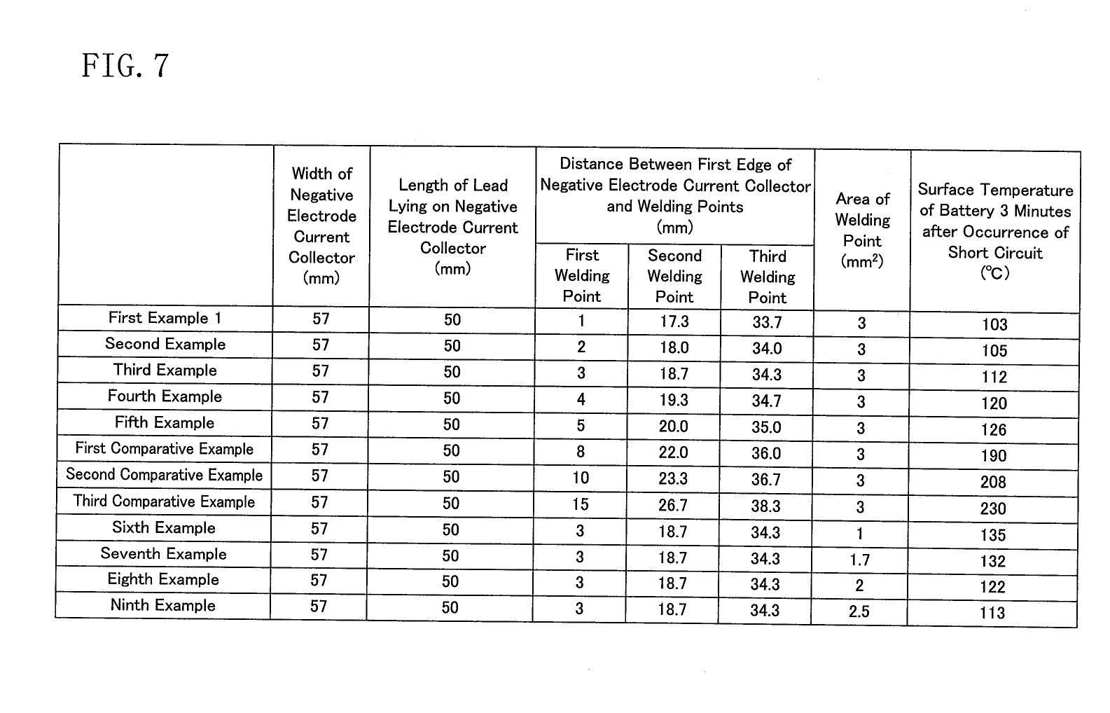

Structures and results of temperature measurement of the fabricated lithium ion secondary batteries are shown in FIG. 7.

As shown in FIG. 7, the battery temperature three seconds after the occurrence of an external short circuit was lower in the batteries of the first to fifth examples (the batteries in which the distance from the first edge of the negative electrode current collector to the first welding point was 5 mm or less) than in the batteries of the first to third comparative examples (the batteries in which the distance from the first edge of the negative electrode current collector to the first welding point was 8 mm or larger). This is presumably because heat generated at the negative electrode lead due to the occurrence of the external short circuit can be rapidly released to the negative electrode current collector in the batteries of the first to fifth examples.

Moreover, the battery temperature three seconds after the occurrence of the external short circuit was much lower in batteries of the third, eighths, and ninth examples (the batteries in which the area of the welding point was 2 mm² or larger) than in the batteries of the sixth and seventh examples (the batteries in which the area of the welding point was smaller than 2 mm²). This is presumably because when the area of the welding point is larger, heat generated at the negative electrode lead can be rapidly released to the negative electrode current collector, and the amount of Joule's heat generated at the welding point can be reduced.

Note that the inventors of the present application confirmed that welding the positive electrode lead to the exposed portion of the positive electrode current collector at a position closer to the first edge of the positive electrode current collector in comparison to conventional configurations can lower the battery temperature three seconds after the occurrence of the external short circuit in comparison to the conventional configurations.

Moreover, the inventors of the present application confirmed that also in square batteries which are different from cylindrical batteries in the positional relationship between the positive electrode lead and the negative electrode lead, welding the negative electrode lead at a position closer to the first edge of the negative electrode current collector in comparison to conventional configurations can lower the battery temperature three seconds after the occurrence of the external short circuit in comparison to the conventional configurations.

### INDUSTRIAL APPLICABILITY

As described above, in a battery according to the present invention, the safety of the battery can be kept at a high level even when a short circuit occurs, so that the battery according to the present invention is preferable as a power source for any apparatuses. The battery according to the present invention can be used as, for example, a power source of personal digital assistants, mobile electric devices, domestic small electric power-storage devices, motorcycles, electric vehicles, hybrid electric vehicles, and the like. Moreover, the battery according to the present invention is applicable to general batteries, and in particular useful for lithium ion secondary batteries.

### DESCRIPTION OF REFERENCE CHARACTERS

1 Positive Electrode
1A Positive Electrode Current Collector
1B Positive Electrode Active Material Layer
2 Negative Electrode
2A Negative Electrode Current Collector
2B Negative Electrode Active Material Layer
3 Separator
4 Electrode Group
5 Positive Electrode Lead
6 Negative Electrode Lead
7 Upper Insulating Plate
8 Lower Insulating Plate
9 Sealing Plate
10 Battery Case
11 Exposed Portion
11a First Edge
21 Exposed Portion
21a First Edge
101 First Welding Point
102 Second Welding Point
103 Third Welding Point
201 First Welding Point
202 Second Welding Point
203 Third Welding Point

1. A battery comprising:
an electrode group formed by winding or stacking a positive electrode and a negative electrode with a porous insulating layer interposed therebetween, the electrode group being sealed in a battery case together with an electrolyte, wherein
at least one of the positive electrode and the negative electrode includes a current collector, and an active material layer provided on a surface of the current collector such that a portion of the surface of the current collector is exposed,
a lead is electrically connected to the exposed portion of the surface of the current collector which is exposed from the active material layer, and
the lead is disposed to extend from the exposed portion to an outside of the current collector such that the lead straddles a first edge which is one of edges constituting the exposed portion, and is welded to the exposed portion at a position close to the first edge.

2. The battery of claim 1, wherein the lead is welded to the exposed portion at a position 5 mm or less away from the first edge.

3. The battery of claim 2, wherein the lead is welded to the exposed portion at a position greater than or equal to 0.1 mm and less than or equal to 3 mm away from the first edge.

4. The battery of claim 1, wherein
the lead is welded to the exposed portion at two or more points, and
a welding point of the welding points which is closest to the first edge has an area larger than that of the other welding point.

5. The battery of claim 4, wherein the welding point of the welding points which is closest to the first edge has an area of 2 mm² or larger.

6. The battery of claim 1, wherein
the lead is welded to the exposed portion at three or more points,
the welding points of the lead to the current collector are disposed at intervals in a longitudinal direction of the lead, and
an interval between a first welding point of the welding points which is located closest to the first edge and a second welding point located adjacent to the first welding point is larger than that between the other welding points adjacent to each other.

7. The battery of claim 1, wherein
the first edge extends in a longitudinal direction of the current collector, and
a length of a portion of the lead which abuts the exposed portion is equal to or less than ⅓ of a length of the current collector in a width direction.

8. The battery of claim 1, wherein the lead is made of nickel.

9. The battery of claim 1, which is a lithium ion secondary battery.
